(19) United States
(12) Patent Application Publication
(10) Pub. No.: US 2002/0073625 A1
(43) Pub. Date: Jun. 20, 2002

(54) Modular closure for motor vehicles and method of making the same

(76) Inventor: Daniel E. Jennings, Birmingham, MI (US)

Correspondence Address: DYKEMA GOSSETT PLLC, 39577 WOODWARD, SUITE 300, BLOOMFIELD HILLS, MI, 48304, US

(21) Appl. No.: 09/874,612

(22) Filed: Jun. 5, 2001

Related U.S. Application Data
(60) Provisional application No. 60/209,667, filed on Jun. 6, 2000.

(51) Int. Cl. B62D 25/04

(52) U.S. Cl. 49/502; 296/146.5

(57) ABSTRACT

A closure assembly for a motor vehicle has a pre-painted outer panel and a pre-painted inner panel. A first of a plurality of peripheral edges of the outer panel is defined by a first flange extending along the first edge and folded back toward the inner surface of the outer panel. The flange defines a gap between itself and the inner surface. The inner panel has an inner surface disposed against the inner surface of the outer panel. The inner panel has a plurality of peripheral edges substantially corresponding to the plurality of peripheral edges of the outer panel. A first of the inner panel peripheral edges has a first flange extending therefrom received by the gap of the outer panel. A second of the inner panel peripheral edges has a second flange overlaying and joined to a second of the peripheral edges of the outer panel. A third of the inner panel peripheral edges has a flange disposed over and extending no further than a third of the peripheral edges of the outer panel. The third edges of the inner and outer panels being adhesively bonded to each other.

### CROSS-REFERENCE TO RELATED APPLICATIONS

This application claims the benefit of U.S. Provisional Application No. 60/209,667, filed Jun. 6, 2000.

### FIELD OF INVENTION

The invention is in the field of forming of motor vehicle components from sheet metal. More particularly, the invention is in the field of forming outer body panels of sheet metal for use in closure assemblies and their application to modular assemblies and other appropriate applications including hood, trunk lids and fenders.

### BACKGROUND OF THE INVENTION

Doors for automotive vehicles have evolved into complex systems which provide not only a closure enabling passenger entry and egress, but also include significant body structure elements, movable windows, mechanisms for displacing the windows, latching and locking mechanisms, and controls for remotely positioning rear view mirrors. Assembling the various components of the doors can be time consuming, labor intensive and expensive.

Commonly, doors structures have been assembled by forming a door inner panel and a door outer panel and joining the two panels together. The door outer panel has the surface which will be seen from the outside of the vehicle. The door inner panel defines the frame of the door which fits within the door opening, defines the volume retaining the various mechanisms and systems disposed within the door, and may also define a window track channel.

The door structure, consisting of the assembled inner panel and outer panel, are then mounted to the vehicle body and painted with the vehicle body at the vehicle assembly plant to ensure adequate color matching.

Subsequent to painting, the window glass, window seals, door seals, window lifting mechanism, interior trim panel, intrusion beams and other components are assembled to the door. This also occur in the vehicle assembly plant. The assorted mechanisms and trim elements are typically mounted to the door inner panel. A large portion of the door inner panel extends parallel to the door outer panel and has mounting features located thereon and access apertures therein to facilitate assembly. However, assembly of the door requires a significant amount of dexterity on the part of the assembler to reach inside the door cavity to attach all of the elements in their desired locations.

An attempt at simplifying the assembly of doors has been to form a door wherein the inner panel has a single access cavity for mounting of door hardware incrementally. In this case, the door inner panel and the door outer panel are assembled together. The door is then painted on the assembly line at the assembly plant, and the hardware installed after the door is painted. The single large access cavity permits the components to be mounted in modular subassemblies. The installation of the soft trim and wiring are installed and serviced consistent with conventional practices in the assembly plant. This assembly process reduces the amount of manpower in the assembly plant needed to assemble the doors, but a drawback of this approach is that it may entail a cost and weight penalty.

In an alternative approach, a door is assembled as previously described except it has a single, more comprehensive module that is installed instead of the individual hardware components. The module, including the door hardware, the soft trim, glass and the wiring, is installed in the door as one component instead of multiple components. The module approach requires significant modifications to the door-in-white in order to facilitate the installation of the module. This approach offers modest cost and weight savings.

Unfortunately, none of these approaches permits the complete off-site assembly of doors as self contained modules. All require painting within the assembly plant after the inner panel has been joined to the outer panel, resulting in both the inner panel and the outer panel being painted the same color. However, often times the interior trim is a different color than the body outer color. If the color of the exterior of the door is visible around the edges of the door trim on the interior part of the door, it is viewed as a quality deficiency. To prevent this, the inner panel must be masked from view by trim, or portions of the inner panel may be painted a color compatible with the interior trim in a separate operation.

Another deficiency with the above stated methods of assembly is that all of these assembly operations place the door outer panel at risk of being damaged during assembly.

Another, somewhat distinct concern, is that the radiuses on the closures of a motor vehicle have radii on their peripheral edges which contribute to gaps between the closures and adjacent panels appearing wider than they actually are.

### BRIEF SUMMARY OF THE INVENTION

It is an object of the present invention to provide a closure requiring no painting or assembly at the motor vehicle assembly plant.

It is also an object of the present invention to provide a closure having edges with smaller radii to minimize the apparent width of gaps between closures and panels.

It is another object of the present invention to provide a door which could be assembled and painted outside of the vehicle assembly plant and shipped to the plant as a module ready for assembling to the body of the automobile.

Yet another object of the present invention is to provide a door having a door outer panel which can be painted separately from the door inner panel and assembled to a separately painted door inner panel, and the door inner panel can be painted to match the trim color.

Still another object of the present invention is to provide a door having a door outer panel which is assembled to the door inner panel only after all the door mechanisms and elements have been assembled to the door inner panel to minimize the risk of damaging the door outer panel during assembly.

And another object of the present invention is to provide a door that can be assembled robotically.

Even yet another object of the present invention is to provide a door wherein all the door functions can be verified prior to shipment to the customer.

The objects of the present invention are achieved by a closure assembly for a motor vehicle having an pre-painted outer panel and a pre-painted inner panel. The outer panel is formed of sheet metal and has an outer surface with a finish coat of a first predetermined color of paint. The outer panel has an oppositely disposed inner surface. The outer surface has a plurality of peripheral edges. A first of the peripheral edges is defined by a first flange extending along the first edge and folded back toward the inner surface. The flange defines a gap between itself and the inner surface. The inner panel is formed of a sheet of metal and has an outer surface with a finish coat of a second predetermined color of paint distinct from the first predetermined color. The inner panel has an oppositely disposed inner surface with the inner surface of the inner panel disposed against the inner surface of the outer panel. The inner panel has a plurality of peripheral edges substantially corresponding to the plurality of peripheral edges of the outer panel. A first of the inner panel peripheral edges has a first flange extending therefrom received by the gap of the outer panel. A second of the inner panel peripheral edges has a second flange overlaying and joined to a second of the peripheral edges of the outer panel. A third of the inner panel peripheral edges has a flange disposed over and extending no further than a third of the peripheral edges of the outer panel. The third edges of the inner and outer panels being adhesively bonded to each other.

A closure assembly for a motor vehicle includes an outer panel and an inner panel. The outer panel is formed of a sheet of metal and has an outer surface and an oppositely disposed inner surface. The outer panel has a plurality of peripheral edges in which a peripheral flange is folded over against the inner surface so that the edges have a radius approximately equal to a thickness of the sheet of metal. An inner panel has a plurality of peripheral edges disposed against the outer panel and disposed within the peripheral edges of the outer panel so as to be concealed from view when viewed from an outside of the closure. The inner panel structurally reinforces the outer panel.

A method of forming a closure for a motor vehicle includes the steps of forming an outer panel and forming an inner panel. An outer panel is stamped from a first sheet of metal. The outer panel has an outer surface and an oppositely disposed inner surface and a plurality of peripheral edges. A first flange is formed along a first of the peripheral edges of the outer panel. The first flange of the outer panel is folded over and toward the inner surface of the outer panel to define a gap between the first flange of the outer panel and the inner surface of the outer panel. The outer panel is painted a first color. A second flange is formed on a second of the peripheral edges of the outer panel. A hem is formed on a third of the peripheral edges of the outer panel. An inner panel is stamped from a first sheet of metal. The inner panel has an outer surface and an oppositely disposed inner surface and a plurality of peripheral edges substantially corresponding to the plurality of peripheral edges of the outer panel. The inner panel is painted a second color distinct from the first color. A first of the peripheral edges of the inner panel is formed to conform to the shape of the gap of the outer panel to enable the first peripheral edge of the inner panel to be received by the gap. A second of the peripheral edges is formed. The second edge has a flange extending therefrom for connecting the inner panel with the outer panel. A third of the peripheral edges, disposed between the first edge and the second edge of the inner panel, is formed. Adhesive material is placed along one of the third edge of the inner panel and the third edge of the outer panel. The inner panel and the outer panel are aligned so that their corresponding peripheral edges are substantially aligned with each other. The inner panel and the outer panel are oriented such that the panels are at an angle to one another with the first edges close to each other and the second edges distal to each other. The first edge of the inner panel are slipped into the gap. The flange of the second edge of the inner panel are brought into engagement with the flange of the second edge of the outer panel. The flanges at the second edges are fixed together, thereby bringing the third edges into engagement with each other and fixing the inner panel to the outer panel.

Other objects, advantages and novel features of the invention will become more apparent from the following detailed description of the invention when taken in conjunction with the accompanying drawings.

### BRIEF DESCRIPTION OF THE DRAWINGS

FIG. 1 is a side elevation view of an assembled door inner panel and door outer panel, viewed from outside the door panel;

FIG. 2 is a sectional view of a hem detail of the door taken along line 2-2 in FIG. 1 showing a fold-over hem on the top edge of the door;

FIG. 3 is a sectional view of the door taken along line 3-3 in FIG. 1 showing an upstanding flange formed in the bottom edge of the door;

FIG. 4 is a sectional view of a hem detail of the door taken along line 4-4 in FIG. 1 showing a rope hem on the side edges of the door;

FIG. 5 is a sectional view of a first embodiment of a hem detail of the door showing a sharp edge hem formed in the top edge of the door;

FIG. 6 is a sectional view of a second embodiment of a hem detail of the door showing a sharp edge hem formed in the side edges of the door;

FIG. 7 is a perspective view of a prior art door, viewed from inside of the door panel;

FIG. 8 is a perspective view of the assembling of the window and various mechanisms in the inner door panel robotically;

FIG. 9 is a perspective view of an assembled door inner panel, viewed from the side where the outer door panel will be attached thereto and showing the window and other mechanisms in place within the inner door panel;

FIG. 10 is a perspective view of an outer door panel being assembled with an inner panel that has the window and other mechanisms in place therewithin; and

FIG. 11 is a side elevation view of an assembled door panel as it is to be mounted in the door opening of an automobile.

### DETAILED DESCRIPTION OF THE INVENTION

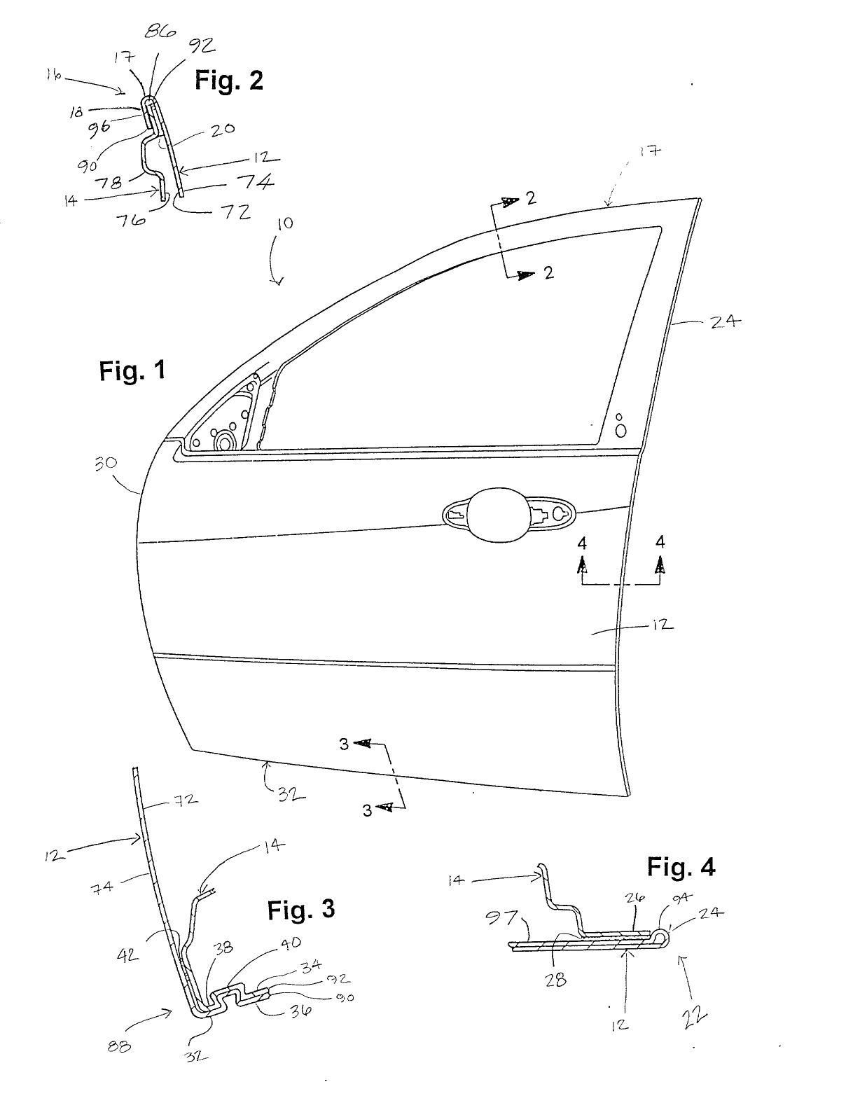

The door outer panel 12 of a door assembly 10 is shown in FIG. 1. The door outer panel has a plurality of peripheral edges, including a top edge 17, a lower edge 32, a forward or front edge 30 and a rear edge 24. The door outer panel 12 is attached to corresponding peripheral edges of an door inner panel 14, including an upper edge 18, a lower edge 34, a front edge 29 and a rear edge 26. A variety of attachment means are employed along the different edges, such as hems which are discussed in detail with regards to FIGS. 2-6. This particular view of the door outer panel 12 does not show some of the attachments typically found on doors, such as the door pull and the mirrors, which are normally present on a finished door assembly 10. They have been omitted for the sake of simplicity.

The door outer panel 12 has an interior surface 72 and an exterior surface 74. The exterior surface 74 of the panel 12 is ultimately on the exterior of the vehicle 80 and is painted to match the exterior color of the vehicle 80 where the door 10 is assembled, which is off-site from the assembly plant of the remainder of the vehicle.

The interior surface 72 is on the side of the door outer panel 12 that is nearest the door interior panel 14, and ultimately ends up in the interior of the door 10 adjacent the interior surface 76 of the door inner panel 14 when the door 10 is fully assembled. The door inner panel 14 also has an exterior surface 78 that is painted to match the interior of the vehicle.

The fold-over hem 16 attaches the top edge 17 of the door outer panel 12 with the top edge 18 of the door inner panel 14 and is shown in FIG. 2. In order to form the fold-over hem 16, the top edge 17 of the door outer panel 12 is folded over towards itself and forms a U-shaped cross-section with a flange or flap portion 96 and the remainder of the door outer panel 12. The flap portion 96 forms a gap 86 when folded back upon the remainder of the door outer panel 12. When fully assembled, the upper edge 18 of the door inner panel 14 is inserted into the gap 86 and secured therein with a bead of adhesive 20.

Lower edge 32 and a corresponding door lower edge 34 of inner door panel 14, as best shown in FIG. 3, are joined together by a combination of a third bead of adhesive 42 disposed between panels 12 and 14 and a plurality of connections 40 between horizontally extending flanges 36 and 38 of panels 12 and 14 respectively. Flanges 36 and 38 extend inboard from edges 32 and 34 respectively toward the center of the vehicle 80.

Connections 40 are preferably TOX® joints. TOX® is a registered trademark of the Tox Pressotechnik GMBH of Germany. TOX® joints are characterized by mushroom shaped projection in the joined pieces as illustrated in FIG. 3. To form a TOX® joint, flanges 36 and 38 are held against each other. A tool pushes against a lower surface of flange 36 and displaces a portion of flange 36 and flange 38 into a cavity of a die engaging flange 38. The displaced material forms TOX® joint 40.

Other types of connections, such as spot welds or rivets, may be employed in place of TOX® joints 40. However, TOX® joints are advantageous in that they do not damage the rust resistant zinc coatings on door panels 12 and 14, and hence on the surfaces of flanges 36 and 38, and are therefore less likely to serve as initiation sites for corrosion than other means of joining panels 12 and 14.

Drain holes, not shown, may also be placed in the portion of inner panel disposed over flanges 36, 38. The flanges 36, 38 advantageously serve as a gutter for fluids draining from inside the door 10 through such drain holes. The flanges 36, 38 may also be used as an attachment for a door sill seal at the bottom of door 10.

FIG. 4 shows a rope hem 22 that is used to terminate the front edge 30 and rear edge 24 of the door outer panel 12. The rope hem 22 is characterized by a rounded lip 94 at edges 24 and 30 which advantageously replicates the feel of a fold over hem 16 to anyone touching edge 24 or 30, as edge 22 and edge 17 have similar radii. A flange or flap portion 97 of hem 22 extends past lip 94 and is folded back against outer panel 12. A rear edge 26 of the door inner panel 14 is butted up against lip 94. A second bead of adhesive 28 is disposed between the rear edge 26 of the door inner panel 14 and the flap portion 97 of lip 94 of the door outer panel 12, and a corresponding bead at the front edge 30, thereby attaching the two panels 12, 14 together at rear and front edges 26 and 30.

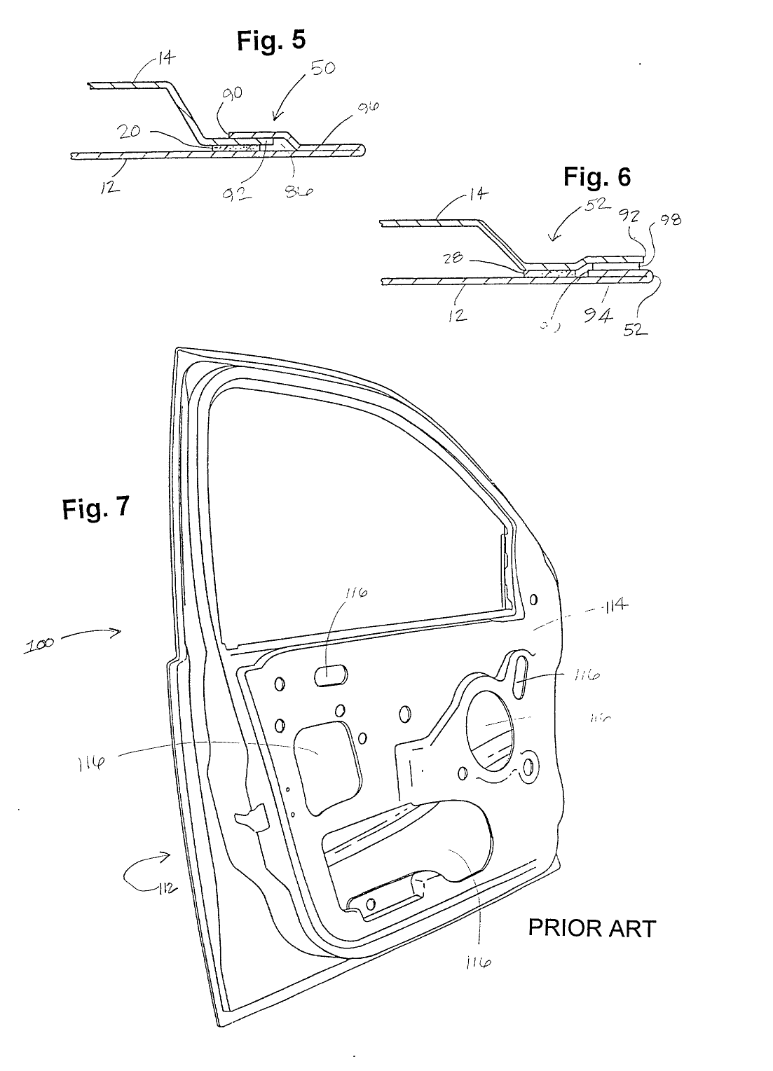

An alternative to the fold over hem 16 and the rope hem 22 is a sharp edge hem 50, shown in a first embodiment in FIG. 5. The sharp edge hem 50 is similar to the fold-over hem 16, as shown in FIG. 1, with the primary difference being in the stepped shape of the folded over flap portion 96 of the top edge 17 of the door outer panel 12. Vehicle quality is imputed to a vehicle in part on the closeness of its closure edges, such as door edges, to the surrounding body structure. It has been discovered that the radius of such an edge has an effect on the perceived size of such a gap. A large radius will result in a larger portion of the edge reflecting more light proximate to the gap away from the observer, and hence will result in a significant portion of the edge being perceived as part of the gap. The sharp edge hem 50 advantageously has a much smaller radius than the fold over hem 16 and the rope hem 22. The smaller radius gives panel 14 the appearance of being closer to the surrounding door opening 82.

As with the fold-over hem 16, the sharp edge hem 50 has a flap portion 96 that is formed by folding the outer edge 90 of the door outer panel 12 back towards itself in a notched fashion wherein a first portion of the flap 96 is directly adjacent the remainder of the door outer panel 12. A second portion of the flap 96 is parallel with, but slightly separated from, the remainder of the door outer panel 12 thereby forming a gap 86.

The gap 86 receives the outer edge 92 of the door inner panel 14, and the outer edge 92 is secured within the gap 86 with an adhesive 20. This sharp edge hem 50 is an alternative means of attaching the top edge 17 of the door outer panel 12 with that of the door inner panel 14.

FIG. 6 illustrates a second embodiment of the sharp edge hem 52 which can also be used as a means of attachment for connecting the door outer panel 12 with the door inner panel 14 at the sides 24, 30 of the door, as an alternative to the rope hem 22.

With the sharp edge hem 52, the outer edge 90 of the door outer panel 12 is folded back upon itself into a flap portion 96 wherein the flap 96 is directly adjacent and in contact with the remainder of the door outer panel 12. This flap 96 forms a step over which is attached the outer edge 92 of the door inner panel 14. The two panels 12, 14 are secured together with two beads of adhesive 28, 98 placed between the outer edge 92 of the door inner panel 14 and the outer edge 96 of the door outer panel 12.

Both the embodiments of the sharp edge hems 50, 52, as shown in FIGS. 5 and 6, reduce the apparent size of the gap between the door 10 and the door opening 82 as noted above.

Sharp edge hems can also be employed on fenders at the door interface, on trunks, and on hoods as well.

FIG. 7 is a perspective view of a typical door assembly 100 of the Prior Art where the door outer panel 112 is attached to the door inner panel 114 at the assembly plant, the door 110 is then mounted to the vehicle and the door outer panel 112 and the door inner panel 114 are painted after being assembled to the vehicle.

In this door 100, the door inner panel 114 has a plurality of access holes 116 formed therein. The access holes 116 provide openings in the door inner panel 114 through which individual hardware components such as glass guides, window glass regulators, speaker connections and wiring harnesses are manually installed. The door trim assembly is then added to cover the access holes 116.

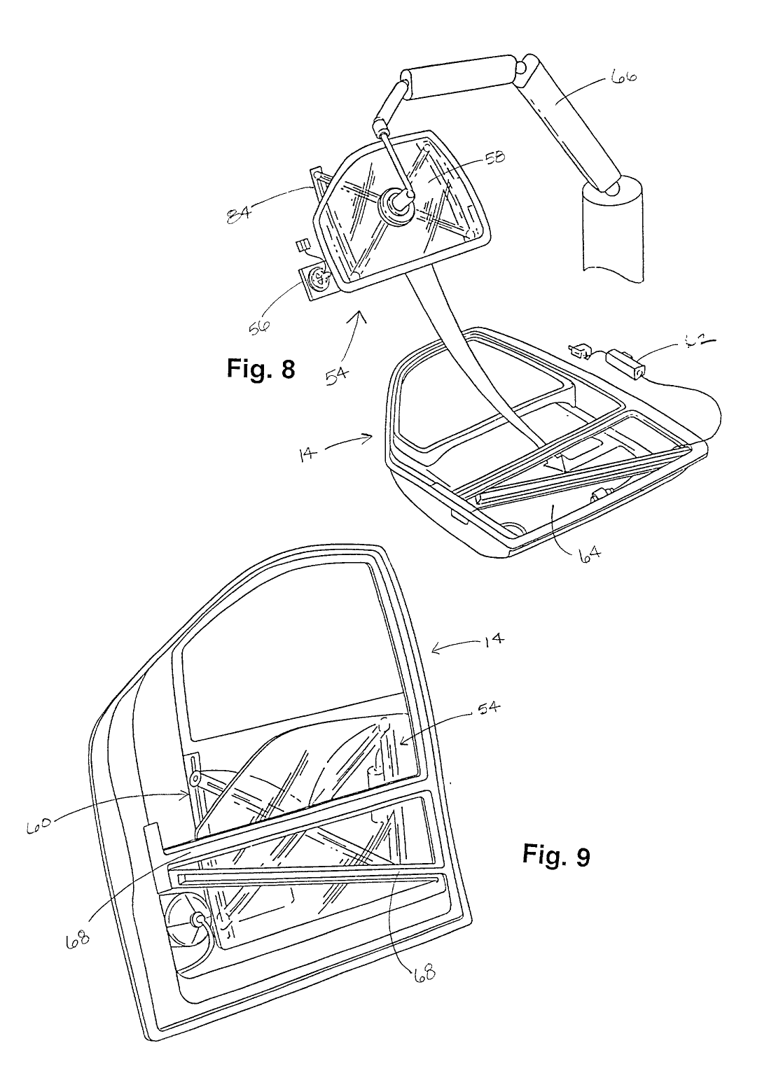

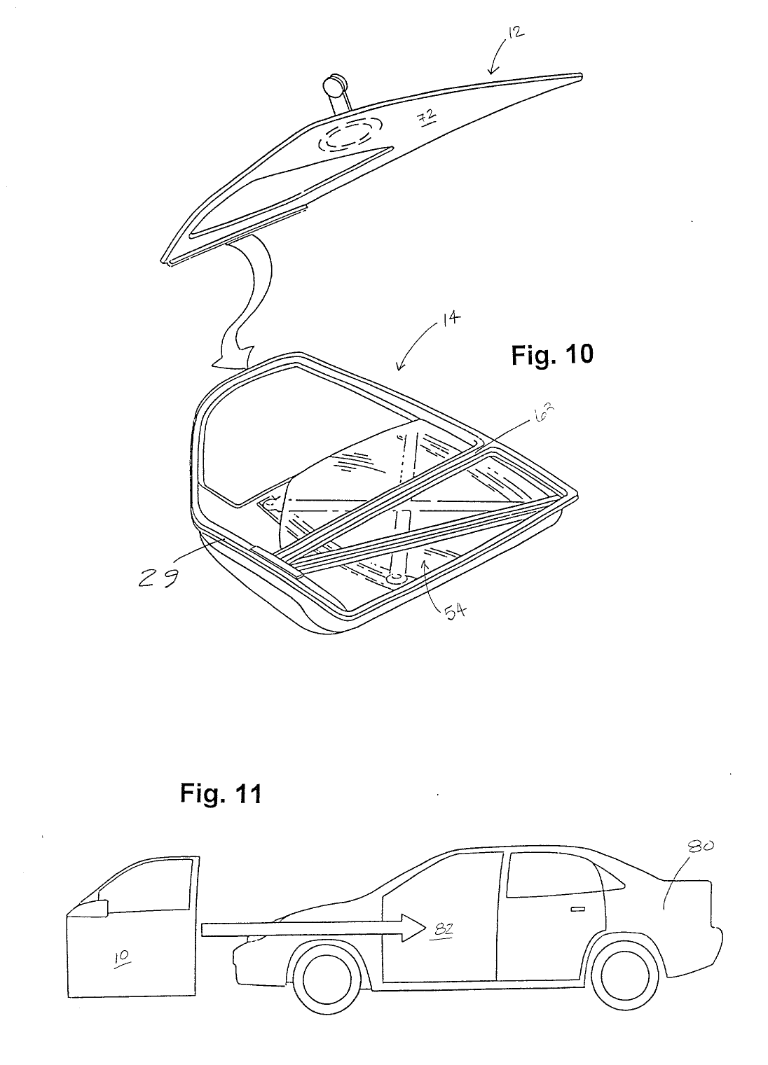

The internal hardware components of the door inner panel 14 of the present invention are capable of being assembled either manually or robotically, as shown in FIGS. 8 and 9. One time and effort saving aspect of the assembly process, is the use of a module 54 that contains the various hardware components such as the window glass 58, the window track system 84 and a speaker connection 56.

The module 54 can be placed within a cavity 64 formed in the door inner panel 14 with a robot 66 as shown in FIG. 8. The wiring 62 of the various hardware components 60 is then connected, completing the assembly of the door inner panel 14. There are various structural supports 68 on the door inner panel 14 that reinforce the door 10 and help retain the module 54 within the cavity 64 as shown in FIG. 9.

A key feature of the door 10 of the present invention is that the door inner panel 14 can be painted prior to the assembly of the module 54 and especially prior to being attached to the door outer panel 12. The benefit of painting the door inner panel 14 separate from the door outer panel 12 is that both panels may ultimately end up being different colors and this method allows for a single painting of each panel, as opposed to multiple paintings thereof. For example, in similar prior art assemblies, the door outer panel 112 and the door inner panel 114 are attached together prior to either panel 112, 114 being painted. Thus, both panels 112, 114 are ultimately painted together resulting in the same color of paint on both panels 112, 114. Then, if the inner door panel 114 is ultimately to be a different color than that of the door outer panel 112, the door inner panel 114 is subjected to another painting process, resulting in a great waste of time, energy and materials.

FIG. 10 illustrates the assembly of the door outer panel 12 to the door inner panel 14. The interior surface 72 of the door outer panel 12 is placed adjacent the module 54 and supports 68 of the door inner panel 14 and attached thereto as described below.

The top edge 17 of panel 12, as noted above, is folded over to define gap 86. Inner panel 14 and outer panel 12 are tipped at an angle to one another with edge 17 being disposed more proximate to the upper edge 18 of the inner panel 14 than are lower edges 32 and 34. Front and rear edges 30 and 24 of outer panel 12 are aligned, as are front and rear edges 29 and 26 of inner panel 14. With the panels thus oriented, and with first bead of adhesive 20 installed, edge 18 is slipped into gap 86. Edges 32 and 34 are moved toward each other, bringing flanges 36 and 38 into engagement with each other. Third bead of adhesive 42 bonds panels 12 and 14 at edges 32 and 34.

When lower edges 32 and 34 are engaged with each other, front and rear edges 30 and 24 of outer panel 12 are fixed to front and rear edges 29 and 26 of inner panel 14 by second bead of adhesive 28 at rear edges 24 and 26 and a fourth bead of adhesive (not shown) at front edges 29 and 30.

Flanges 36 and 38 are fixed to each other by connections 40. TOX® joints 40 are formed, projecting upward from flange 38 in a plurality of locations. If necessary, the portion of flap portion 96 defining gap 86 may be pressed on to ensure its engagement against edge 18.

The assembly of the door outer panel 12 and the door inner panel 14 can be advantageously performed at an offsite door manufacturing plant, as well as the assembly of the hard and soft trim and the painting of the door panels 12, 14. Precise color matching between doors and car bodies can be achieved through temperature scans of painted panels 12 and scans of painted vehicles at the automobile assembly plant. Broadcasts from the automobile assembly plant would specify the exact color and a matching panel 12 would be selected to ensure an exact color match of the door outer panel 12 with the exterior of the vehicle. While the painted interior surfaces of the vehicle will in most cases not require such precise color matching, such matching could be done to provide an exact match of the color of the door inner panel 14 with the color of the interior of the vehicle.

The door 10, as shown in FIG. 11, is then connected to the automobile 80 in the assembly plant through conventional means such as a plurality of fasteners, and the electrical wiring of the door is connected to the electrical wiring of the vehicle.

In summary, a door panel 10 is formed from a door outer panel 12 with a top edge 17, a bottom edge 32, and side edges 24, 29; and a door inner panel 14 with a corresponding upper edge 18, a bottom edge 34 and side edges 26, 30.

In manufacturing outer panel 12, a blank for panel 12 is stamped from a sheet of steel. The periphery of the blank for panel 12 is defined by the outer edge 90. Top edge 17 is formed by bending over flap 96. Flap 96 defines gap 86. Edges 24 and 30 are formed by folding over the panel's leading and trailing edges.

The rear and front edges 24, 30 of the door outer panel 12 are prepared by folding over edge 90 to form either creating a rope hem 94 or a sharp edged hem 88.

A flange 36 is formed on the bottom of panel 12, defining the lower edge 32 of the door outer panel 12.

The outer surface 74 of the door outer panel 12 is painted. If the panel is to be painted before forming edges 17, 32, 24 and 30, the paint must be able to sustain deformation of the panel 12 being deformed without separating from panel 12. Otherwise, the panel 12 is best painted after it is completely formed to shape. The color of the paint of the vehicle body may actually be determined at the vehicle assembly plant and that color information is then transmitted to the plant where the door 10 is being assembled. More precise color matching may be achieved by spraying a large number of panels 12 in the same “target” color. A matrix of acceptable color variations around the target color is established. Painted panels 12 are inventoried according to their location on the color matrix.

In manufacturing inner panel 14, a blank for panel 14 is stamped from a sheet of steel. The periphery of the blank for panel 14 is defined by the outer edge 92. Additional forming operations form the cavity 64 of inner panel.

A flange 38 is formed on the bottom edge 34 of the door inner panel 14 for connection with the door outer panel flange 36.

Structural supports 68 are fixed to the inner panel 14.

The door inner panel 14 is painted to match the interior of the vehicle, with the paint color information being specified by the vehicle assembly plant or elsewhere. Alternatively, an inventory of inner panels 14 of a variety of specified colors can be established. An inner panel 14 of the desired color is pulled from inventory in accord with the vehicle broadcast sheet.

The module 54 including hardware 60, glass 58, wiring 62, speaker connections 56, and so on, is then installed within the cavity 64 of the door inner panel 14 either manually or robotically.

A pre-painted outer panel 12 of the color specified on the vehicle broadcast is pulled from inventory and mated to the inner panel 14 and module 54 assembly, already built to the vehicle broadcast sheet specifications.

The upper edge 18 of the door inner panel 14 is received by the top edge 17 of the door outer panel 12. Adhesive 20 is added therebetween to hold edges 17 and 18 together.

Side edges 26, 30 of the door inner panel 14 are joined with the side edges 24, 30 of the door outer panel 12 by adhesive 28.

A few advantages of the present invention are that the work-in-process storage areas, both at the vehicle assembly plant and at the door assembly location, are minimized, the doors 10 are fully assembled off-site from the vehicle assembly plant, all the door functions are verified prior to being shipped to the assembly plant, and damage to the painted door panels 12, 14 is avoided. With the inventive process, it is also easy to ship the finished doors 10 in sequence to the Customer based on their broadcast or request thereof.

Although particular embodiments of the invention have been described in detail herein with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A closure assembly for a motor vehicle, comprising:
a pre-painted outer panel formed of a sheet of metal and having an outer surface with a finish coat of a first predetermined color of paint and the outer panel having an oppositely disposed inner surface,
the outer panel having a plurality of peripheral edges,
a first of the outer panel peripheral edges defined by a first flange extending along the first edge and folded back toward the inner surface and the flange defining a gap between itself and the inner surface; and
a pre-painted inner panel formed of a sheet of metal and having an outer surface with a finish coat of a second predetermined color of paint distinct from the first predetermined color and the inner panel having an oppositely disposed inner surface with the inner surface of the inner panel disposed against the inner surface of the outer panel,
the inner panel having a plurality of peripheral edges substantially corresponding to the plurality of peripheral edges of the outer panel,
a first of the inner panel peripheral edges having a first flange extending therefrom received by the gap of the outer panel;
a second of the inner panel peripheral edges having a second flange overlaying and joined to a second of the peripheral edges of the outer panel, and
a third of the inner panel peripheral edges having a flange disposed over and extending no further than a third of the peripheral edges of the outer panel and the third edges of the inner and outer panels being adhesively bonded to each other.

2. The assembly of claim 1, wherein:
the outer panel second edge has a second flange extending substantially perpendicular to the outer panel and toward the inner panel;
the inner panel second edge has a second flange overlapping the flange of the outer panel; and
a plurality of nested projections are formed in the overlapping second flanges and positively connect the second flanges to each other.

3. The assembly of claim 1, wherein:
the outer panel third edge has a rope hem defined by a flange folded against the inner surface of the outer panel and the rope hem having a lip at the third edge; and
the inner panel third edge overlaps the flange of the outer panel third edge and the inner panel third edge is disposed inboard of the lip.

4. The assembly of claim 3, further comprising:
a layer of adhesive material is disposed between the flange of the outer panel third edge and the inner surface of the inner panel at its third edge.

5. The assembly of claim 1, wherein the assembly is a door and the inner panel is formed to define a cavity in which is disposed a hardware module including window operating hardware and a window.

6. The assembly of claim 1, wherein:
the first flange and the third flange of the outer panel are pressed tightly against the inner side of the outer panel at the first edge and at the third edge respectively, thereby defining sharp first and third edges, the sharp edges having a radius of approximately twice the thickness of the sheet of which the outer panel is formed, and the first flange of the outer panel having a portion which deflects away from the panel at a location inboard of the first edge to define the gap at a location spaced inboard from the first edge; and
the inner panel third edge has an outermost portion thereof adhesively bonded to at least one of an inner surface of the outer panel and the outer panel third flange, the inner panel first edge being configured to be received by the gap.

7. The assembly of claim 6, wherein:
a layer of adhesive material is disposed between the flange of the outer panel third edge and the inner surface of the outer panel at its third edge.

8. The assembly of claim 6, wherein the assembly is a door and the inner panel is formed to define a cavity in which is disposed a hardware module including window operating hardware and a window.

9. A method of forming a closure for a motor vehicle comprising the steps of:
stamping an outer panel from a first sheet of metal, the outer panel having an outer surface and an oppositely disposed inner surface and a plurality of peripheral edges;
forming a first flange along a first of the peripheral edge of the outer panel and folding the first flange of the outer panel over and toward the inner surface of the outer panel to define a gap between the first flange of the outer panel and the inner surface of the outer panel;
painting the outer panel a first color;
forming a second flange on a second of the peripheral edges of the outer panel;
forming a hem on a third of the peripheral edges of the outer panel;
stamping an inner panel from a second sheet of metal, the inner panel having an outer surface and an oppositely disposed inner surface and a plurality of peripheral edges substantially corresponding to the plurality of peripheral edges of the outer panel;
painting the inner panel a second color distinct from the first color;
forming a first of the peripheral edges of the inner panel to conform to the shape of the gap of the outer panel to enable the first peripheral edge of the inner panel to be received by the gap;
forming a second of the peripheral edges, the second edge having a flange extending therefrom for connecting the inner panel with the outer panel;
forming a third of the peripheral edges disposed between the first edge and the second edge of the inner panel;
placing adhesive material along one of the third edge of the inner panel and the third edge of the outer panel;
aligning the inner panel and the outer panel so that their corresponding peripheral edges are substantially aligned with each other;
orienting the inner panel and the outer panel such that the panels are at an angle to one another with the first edges close to each other and the second edges are distal to each other;
slipping the first edge of the inner panel into the gap;
bringing the flange of the second edge of the inner panel into engagement with the flange of the second edge of the outer panel;
fixing the flanges at the second edges together, thereby bringing the third edges into engagement with each other and fixing the inner panel to the outer panel.

10. The method of claim 9, wherein:
the closure is a door and the inner panel defines a cavity and the method includes the additional step of installing a module of hardware and glass in the cavity.

11. The method of claim 10, wherein:
the step of installing the module is performed by a robot.

12. The method of claim 9, further including the step of:
matching the paint of the outer panel with that of the exterior paint of a vehicle prior to painting the outer panel.

13. A method of forming a door panel from an outer panel with a top edge, bottom edge, and side edges, and an inner panel with a corresponding top edge, bottom edge and side edges, the method comprising the steps of:
preparing the top edge of the outer panel;
preparing the at side edges of the outer panel;
forming a flange on the bottom edge of the outer panel;
determining the paint color of the outer panel;
painting the outer panel;
determining the paint color of the inner panel;
painting the inner panel;
preparing the top edge of the inner panel for connection with the outer panel top edge;
preparing the side edges of the inner panel for connection with the outer panel side edges;
forming a flange on the bottom edge of the inner panel for connection with the outer panel flange;
joining the prepared top edge of the inner panel and with the prepared top edge the outer panel and adding adhesive therebetween;
joining the prepared side edges of the inner panel with the prepared side edges of the outer panel and adding adhesive therebetween; and
joining the inner panel flange with the outer panel flange and adding adhesive therebetween; and
installing a module of hardware, glass, electrical components and seals within the inner panel.

14. A closure assembly for a motor vehicle, comprising:
an outer panel formed of a sheet of metal and having an outer surface and an oppositely disposed inner surface,
the outer panel having a plurality of peripheral edges in which a peripheral flange is folded over against the inner surface so that the edges have a radius approximately equal to a thickness of the sheet of metal; and
an inner panel having a plurality of peripheral edges disposed against the outer panel and disposed within the peripheral edges of the outer panel so as to be concealed from view when viewed from an outside of the closure, the inner panel structurally reinforcing the outer panel.

15. A closure assembly as claimed in claim 14, further comprising:
a first of the outer panel peripheral edges defined by a first flange extending along the first edge defining a gap between itself and the inner surface distal to the first edge; and
the inner panel having a first peripheral edge thereof disposed with the gap.

16. A closure assembly as claimed in claim 15, further comprising:
one of the outer panel peripheral edges being overlaid by a corresponding one of the peripheral edges of the inner panel with a layer of adhesive being disposed therebetween.
